(19) United States
(12) Patent Application Publication
(10) Pub. No.: US 2010/0169133 A1
(43) Pub. Date: Jul. 1, 2010

(54) METHOD TO ENABLE OPTIMIZING TOWARDS GOALS

(75) Inventor: Moshe Ben Bassat, Lexington, MA (US)

Correspondence Address: KATTEN MUCHIN ROSENMAN LLP, 575 MADISON AVENUE, NEW YORK, NY, 10022-2585, US

(73) Assignee: CLICKSOFTWARE TECHNOLOGIES LTD., Giv'at Shmuel (IL)

(21) Appl. No.: 12/344,886

(22) Filed: Dec. 29, 2008

(51) Int. Cl. G06N 5/02; G06Q 10/00

(52) U.S. Cl. 705/7; 706/52

(57) ABSTRACT

A method to provide a goal function solution to an optimization problem. The goal function includes weighted parameters and is performed over a series of data instances. The method includes identifying the parameters of the goal. The method also includes estimating the numerical range each parameter weight factor may take by determining the minimal and maximal numerical value for any realistic solution, normalizing all parameters, setting a maximum weight value, setting a numerical weight for each parameter, searching for a goal function solution by searching for a good assignment of weight for each parameter, analyzing the series of instances, averaging the weights of the best goal functions obtained for each data instance to obtain a single goal function, determining whether one goal function is good for all instances and determining whether more than one goal function is required, so that each goal function is appropriate for at least one operational characteristics, and can be activated when the character of each new instance is recognized.

### FIELD OF THE INVENTION

The present invention generally relates to method for enterprise management, and more particularly to a method identifying optimization goals and striving to meet these goals.

### BACKGROUND OF THE INVENTION

Generally, in an optimization problem, the first requirement is a definition of the “goal function,” typically a linear weighted combination of various measures defined over possible solutions. These measures are almost always interdependent. That is, there is interaction and manipulation of the solution parameters. However, changing one measure inevitably changes the other measures. Therefore, the traditional method of defining the “Goal function” uses weights to rank various “compromise solutions,” so that some of them are preferred over the others. Then, the optimization process involves evaluating various solutions and selecting the best solution found, according to the ranking imposed by the Goal function. Several methods are in use for constructing solutions which comply with the specific problem's constraints, and for searching for solutions with progressively higher values of the Goal function.

However, it has long been known that it is quite difficult to define a Goal function which imposes an ordering on solutions so that this ordering is close enough to the ordering the human user would select, if that user could evaluate all the solutions. Partly, this is because different humans, all highly qualified, will have different opinions, but a more important reason is that the Goal function's parameters are each defined on a different scale. For example, when searching for an optimized operation plan, there will be some parameters expressed in financial terms of costs and of revenue, but there will be other parameters regarding user satisfaction, employee satisfaction, impact on other operations conducted by the same company, etc.

The mathematical nature of traditional Goal function modeling requires that each of these parameters be expressed using the same numerical scale, and that appropriate weights be selected. In practice, human users do not generally agree with these results, leading to “optimized” solutions, which may be mathematically optimal or near-optimal, but which users find unsatisfactory. This leads to sub-optimal performance and may lead to users rejecting the optimization approach as unacceptable.

Furthermore, in real life there are different situations, each of which gives rise to a different ranking of solutions. For example, if the optimization is for scheduling, then under heavy workloads the Goal function might weigh faster completion as more important than cheap completion because new tasks might arrive at any moment, whereas under light workloads cheap completion would receive higher weights. The challenges of identifying such situations and determining how many Goal functions are required are even more complex than the challenge of aligning the mathematically defined Goal function with the subjective human judgment as described above.

Thus, it would be advantageous to provide a method to arrive at a Goal function which is generally acceptable to users.

### SUMMARY OF THE INVENTION

Accordingly, it is a principal object of the present invention to provide a method to arrive at a Goal function which is generally acceptable to users.

It is one more principal object of the present invention to provide a method comprising more supportive software algorithms and iterated interactions with the user.

A method is disclosed to provide a goal function solution to an optimization problem. The goal function includes weighted parameters and is performed over a series of data instances. The method includes identifying the parameters of the goal. The method also includes estimating the numerical range each parameter weight factor may take by determining the minimal and maximal numerical value for any realistic solution, normalizing all parameters, setting a maximum weight value, setting a numerical weight for each parameter, searching for a goal function solution by searching for a good assignment of weight for each parameter, analyzing the series of instances, averaging the weights of the best goal functions obtained for each data instance to obtain a single goal function, determining whether one goal function is good for all instances and determining whether more than one goal function is required, so that each goal function is appropriate for at least one operational characteristics, and can be activated when the character of each new instance is recognized.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is an exemplary flow chart of steps 1-4 of the optimization method, constructed in accordance with an embodiment of the invention;

FIG. 2 is an exemplary flow chart of steps 6-15 of the optimization method, constructed in accordance with an embodiment of the invention;

FIG. 3 is an exemplary flow chart of step 12 of the optimization method, constructed in accordance with an embodiment of the invention; and

FIG. 4 is an exemplary flow chart of step 16 of the optimization method for a variety of instances, constructed in accordance with an embodiment of the invention.

### DETAILED DESCRIPTION OF A PREFERRED EMBODIMENT

The principles and operation of a method and an apparatus according to the present invention may be better understood with reference to the drawings and the accompanying description, it being understood that these drawings are given for illustrative purposes only and are not meant to be limiting.

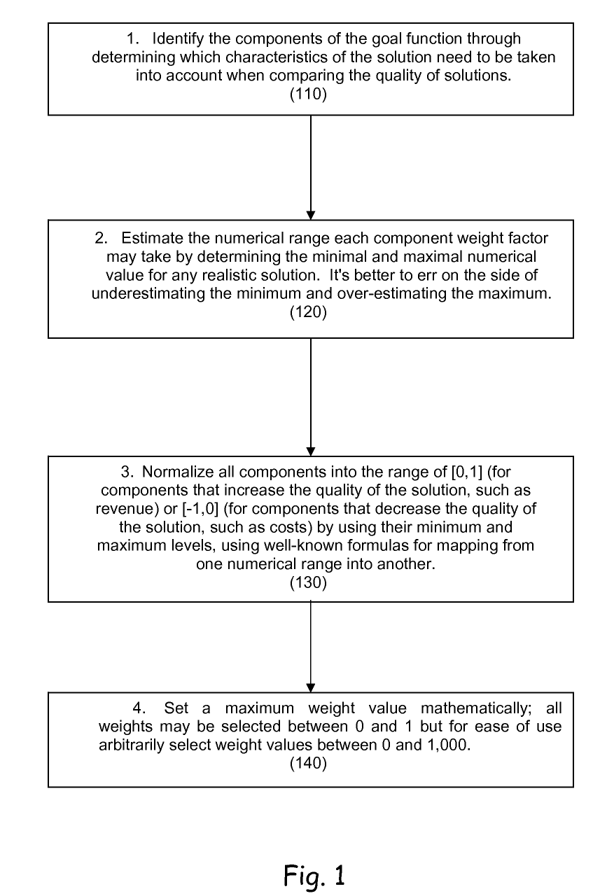

FIG. 1 is an exemplary flow chart of steps 1-4 of the optimization method, constructed in accordance with an embodiment of the invention.

1. First, identify the parameters of the goal function through determining which characteristics of the solution need to be taken into account when comparing the quality of solutions 110.

2. Estimate the numerical range each parameter weight factor may take by determining the minimal and maximal numerical value for any realistic solution. When in doubt, it is better to err on the side of underestimating the minimum and over-estimating the maximum 120.

3. Normalize all parameters into the range of [0,1] for parameters that increase the quality of the solution, such as revenue. Use the range [−1,0] for parameters that decrease the quality of the solution, such as costs, by using their minimum and maximum levels using well-known formulas for mapping from one numerical range into another 130.

4. Set a maximum weight value. Mathematically, all weights may be selected between 0 and 1, but for ease of use weight values between 0 and 1,000 are arbitrarily used for the selection range 140.

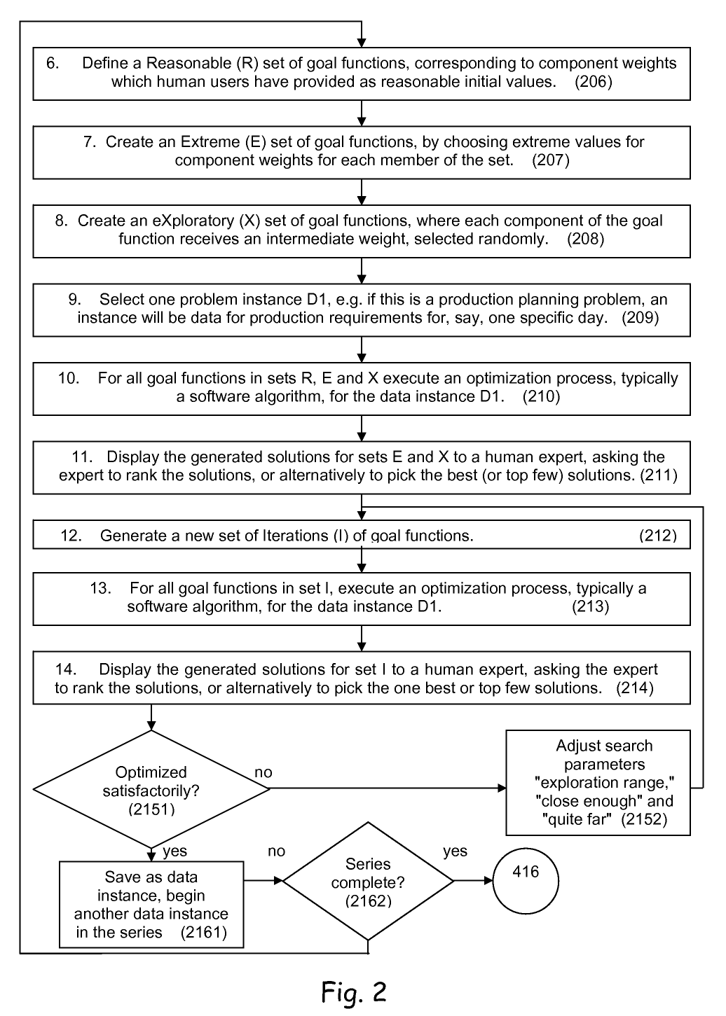

FIG. 2 is an exemplary flow chart of steps 6-15 of the optimization method for a single data instance, constructed in accordance with an embodiment of the invention.

5. In steps 6-15 the search for a goal function means a search for a good assignment of weight for each parameter. I.e., saying “define a goal function” is equivalent to saying “set a numerical weight for each parameter.”

6. Define a set of Reasonable (R) Goal functions, corresponding to parameter weights, which human users have provided as reasonable initial values. This set typically has only a few members, although it could be empty 206.

7. Create a set of Extreme (E) goal functions, by choosing extreme values for parameter weights. For each member of the set, only one parameter of the Goal function receives a weight of 1,000, while all other parameters receive zero weights. Optionally, this is done only for those components of the Goal function which increase the value of the solution, since in many cases an empty solution is optimal if this is done for the other components. This depends on how the problem constraints are defined. Thus, the optimization, when using such a member, will strive to generate only solutions which maximize or minimize the component of the Goal function whose corresponding parameter has non-zero weight. The size of this set is the number of the Goal function parameter 207.

8. Create a set of eXploratory (X) Goal functions, where each parameter of the Goal function receives an intermediate weight. The weights are selected randomly, optionally using a triangular or Gaussian probability distribution centered around the weights in set R. The size of this set is comparable to the size of sets E and R, typically around ten functions 208.

9. Select one problem instance D₁. E.g., if this is a production planning problem, an exemplary instance will be data for production requirements for one specific day 209.

10. For all Goal functions in sets R, E and X, execute an optimization process, typically a software algorithm, for the data instance D₁. For each such function, the process strives to find the solution that maximizes the value of that function 210.

11. Display the generated solutions for sets E and X to a human expert, asking the expert to rank the solutions, or alternatively to pick the one or a few best solutions. As the number of solutions using this method typically does not exceed 20, and can be set lower by selecting other sizes for E and X, this can be done readily by a human 211.

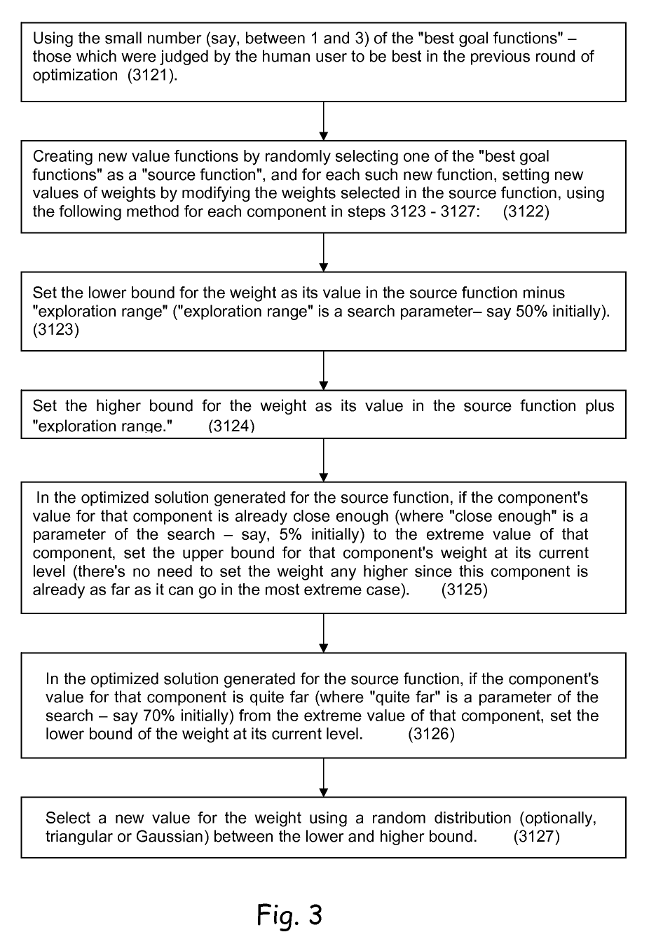

FIG. 3 is an exemplary flow chart of step 12 of the optimization method, constructed in accordance with an embodiment of the invention.

12. Step 12 generates a new set 1, “Iterations” of goal functions, based on:
a. Use a small number, e.g., between 1 and 3, of the “best goal functions.” I.e., use those which were judged by the human user to be best in the previous round of optimization 3121.
b. Creating new value functions by randomly selecting one of the “best goal functions” as a “source function”, and for each such new function, setting new values of weights by modifying the weights selected in the source function, using the following method for each parameter in the following steps 3123-3127:
   i. Set the lower bound for the weight as its value in the source function minus “exploration range,” where “exploration range” is a parameter of the search, e.g., 50% initially 3123.
   ii. Set the higher bound for the weight as its value in the source function plus “exploration range” 3124.
   iii. In the optimized solution generated for the source function, if the parameter's value is already close enough to the extreme value of that parameter, set the upper bound for that parameter's weight at its current level. There's no need to set the weight any higher since this parameter is already as far as it can go in the most extreme case. “Close enough” is another parameter of the search, e.g., 5% initially, 3125.
   iv. In the optimized solution generated for the source function, if the parameter's value for that parameter is quite far from the extreme value of that parameter, set the lower bound of the weight at its current level. “Quite far” is a parameter of the search, e.g., 70% initially 3126.
   v. Select a new value for the weight using a random distribution between the lower and higher bound. Optionally, a triangular or Gaussian random distribution is used 3127.

13. For all Goal functions in set I, execute an optimization process, e.g., a software algorithm, for the data instance D1. With reference now to FIG. 2, for each such function, the process strives to find the solution that maximizes the value of that function 213.

14. Display the generated solutions for set I to a human expert, asking the expert to rank the solutions, or alternatively to pick the best (or top few) solutions 214.

15. Repeat steps 12-14 for several iterations. If the Goal function is not optimized satisfactorily 2151 adjust the search parameters “exploration range”, “close enough” and “quite far” in order to refine and fine-tune the best solutions found so far 2152. If the Goal function is optimized satisfactorily 2151:

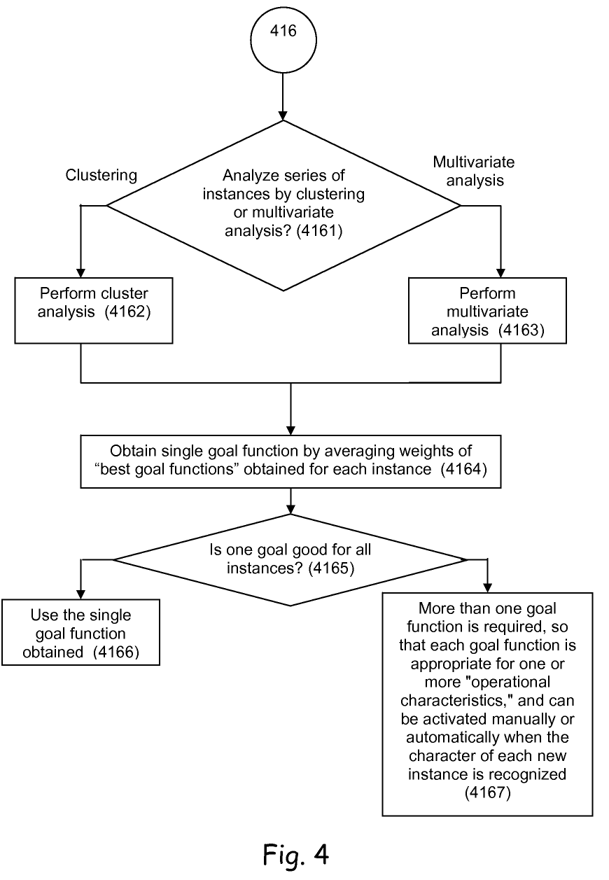

16. In steps 5-16 an optimization for one data instance, D₁ has been completed. Repeat steps 6-15 for other data instances, so that several characteristic instances in a series, e.g. light load, normal load, high load, are processed. At the end of each data instance, save the result 2161. If the series is not complete 2162, begin another data instance in the series 2163. If the series is complete 2162, continue with to the analysis phase 416 described with reference to FIG. 4 below.

FIG. 4 is an exemplary flow chart of step 16 of the optimization method for a variety of instances 416, constructed in accordance with an embodiment of the invention.

At this point it is decided 4161 whether to use clustering analysis 4162 or multivariate analysis 4163, for example. Having obtained a single Goal function by averaging the weights of the “best Goal functions” obtained for each instance 4164, determine whether one of the following is true 4165:
a. One Goal function is good for all instances 4166; or
b. More than one Goal function is required, so that each goal function is appropriate for one or more “operational characteristics”, and can be activated manually or automatically when the character of each new instance is recognized 4167.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

We claim:

1. A method to provide a goal function solution to an optimization problem, wherein the goal function comprises weighted parameters, and wherein said goal function is generally acceptable to users, and wherein said optimization is performed over a series of data instances, said method comprising:
identifying the parameters of the goal function through determining which characteristics of the solution need to be taken into account when comparing the quality of solutions;
estimating the numerical range each parameter weight factor may take by determining the minimal and maximal numerical value for any realistic solution;
normalizing all parameters into the range of [0,1] for parameters that increase the quality of the solution and the of range [−1,0] for parameters that decrease the quality of the solution;
setting a maximum weight value;
setting a numerical weight for each parameter;
searching for a goal function solution by searching for a good assignment of weight for each parameter;
analyzing the series of instances; and
averaging the weights of the best goal functions obtained for each data instance to obtain a single goal function,
so that each goal function is appropriate for at least one operational characteristic, and can be activated when the character of each new instance is recognized.

2. The method of claim 1, further comprising determining whether one goal function is good for all instances.

3. The method of claim 1, further comprising determining whether more than one goal function is required.

4. The method of claim 1, wherein during the estimating step it is better to err on the side of underestimating the minimum and over-estimating the maximum.

5. The method of claim 1, wherein parameters that increase the quality of the solution comprise at least revenue.

6. The method of claim 1, wherein parameters that decrease the quality of the solution comprise at least costs

7. The method of claim 1, wherein normalizing parameters is performed by using minimum and maximum levels of said parameters in coordination with well-known formulas for mapping from one numerical range into another.

8. The method of claim 1, wherein all weights are selected between 0 and 1

9. The method of claim 1, wherein all weight values are selected between 0 and 1,000.

10. The method of claim 1, wherein said analyzing comprises one of cluster analysis and multivariate analysis.

11. The method of claim 1, wherein said activation is one of manual and automatic.
